(19) United States
(12) Patent Application Publication
(10) Pub. No.: US 2017/0257181 A1
(43) Pub. Date: Sep. 7, 2017

(54) Method and Computer System for Reducing Inter-Cell Interference and Inter-Antenna Interference in Wireless Communication System

(71) Applicants: National Taiwan University, Taipei City (TW); MEDIATEK INC., Hsin-Chu (TW)

(72) Inventors: Tzi-Dar Chiueh, Taipei City (TW); Yi-Yao Lan, Tainan City (TW)

(21) Appl. No.: 15/063,469

(22) Filed: Mar. 7, 2016

(51) Int. Cl. H04J 11/00; H04L 1/00; H04L 5/00

(52) U.S. Cl. CPC H04J 11/005; H04L 5/006; H04L 1/004

(57) ABSTRACT

A method for reducing an inter-cell interference (ICI) and an inter-antenna interference (IAI) in a wireless communication system is disclosed. The method includes generating a first candidate signal list and a second candidate signal list, wherein the first candidate signal list relates to transmission data signals, and the second candidate signal list relates to interference signals; processing, via a detector, a first loop operation, and processing, via a decoder, a second loop operation, to update the first candidate signal list and the second candidate signal list; and after iteratively processing the first loop operation and the second loop operation, utilizing the updated first candidate signal list and the updated second candidate signal list to recover the transmission data signal with less complexity and latency.

### BACKGROUND OF THE INVENTION

1. Field of the Invention

The present invention relates to a method and a computer system for reducing inter-cell interference (ICI) and inter-antenna interference (IAI) in a wireless communication system, and more particularly, to a method and computer system utilizing two loop operations and two updated candidate signal lists for reducing the ICI and the IAI in a wireless communication system.

2. Description of the Prior Art

Conventionally, the successive interference cancellation (SIC) and the joint detection are applied to reduce interferences in a wireless communication system, which may have inter-cell interference (ICI) and inter-antenna interference (IAI) as well. Specifically, since the joint detection considers all possible transmission data signals as well as all possible interference signals, an estimation for recovering transmission data signal with higher accuracy may be obtained. However, due to considering all possible combinations of transmission data signals and interference signals, the joint detection needs longer calculating periods and more computing complexity to obtain an accurate result. Alternatively, the SIC initially determines a single most likely interference signal under the assumption of ignoring the component contributed by the transmission data signal, and then handles all possible transmission data signals given this estimated interference signal. In comparison with the joint detection, the SIC can save more calculating periods due to less complexity, but the initial assumption that only single interference signal is considered may result in a higher bit error rate (BER) due to an error propagation issue when such single interference signal is erroneously estimated.

Therefore, it has become an important issue to provide another approach to adaptively reduce the ICI and the IAI in a wireless communication system with less latency and higher accuracy.

### SUMMARY OF THE INVENTION

Therefore, the primary objective of the present invention is to provide a method and a computer system having lower BER and less calculating periods for reducing the ICI and the IAI in a wireless communication system.

The present invention discloses a method for reducing an inter-cell interference (ICI) and an inter-antenna interference (IAI) in a wireless communication system. The method comprises generating a first candidate signal list and a second candidate signal list, wherein the first candidate signal list relates to transmission data signals, and the second candidate signal list relates to interference signals; processing, via a detector, a first loop operation, and processing, via a decoder, a second loop operation, to update the first candidate signal list and the second candidate signal list; and after iteratively processing the first loop operation and the second loop operation, utilizing the updated first candidate signal list and the updated second candidate signal list to recover the transmission data signal with less complexity and latency.

The present invention further discloses a computer system, coupled to a wireless communication system comprising a detector and a decoder. The computer system comprises a central processor; and a storage device, coupled to the central processor, for storing a program code; wherein the program code instructs the central processor to execute a method for reducing an inter-cell interference (ICI) and an inter-antenna interference (IAI) in the wireless communication system. The method comprises generating a first candidate signal list and a second candidate signal list, wherein the first candidate signal list relates to transmission data signals, and the second candidate signal list relates to interference signals; processing, via the detector, a first loop operation, and processing, via the decoder, a second loop operation, to update the first candidate signal list and the second candidate signal list; and after iteratively processing the first loop operation and the second loop operation, utilizing the updated first candidate signal list and the updated second candidate signal list to recover the transmission data signal with less complexity and latency.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a computer system coupled to a wireless communication system according to an embodiment of the invention.

FIG. 2 illustrates a schematic diagram of another wireless communication system according to an embodiment of the invention.

FIG. 3 illustrates a flow chart for the wireless communication system shown in FIG. 2 according to an embodiment of the invention.

### DETAILED DESCRIPTION

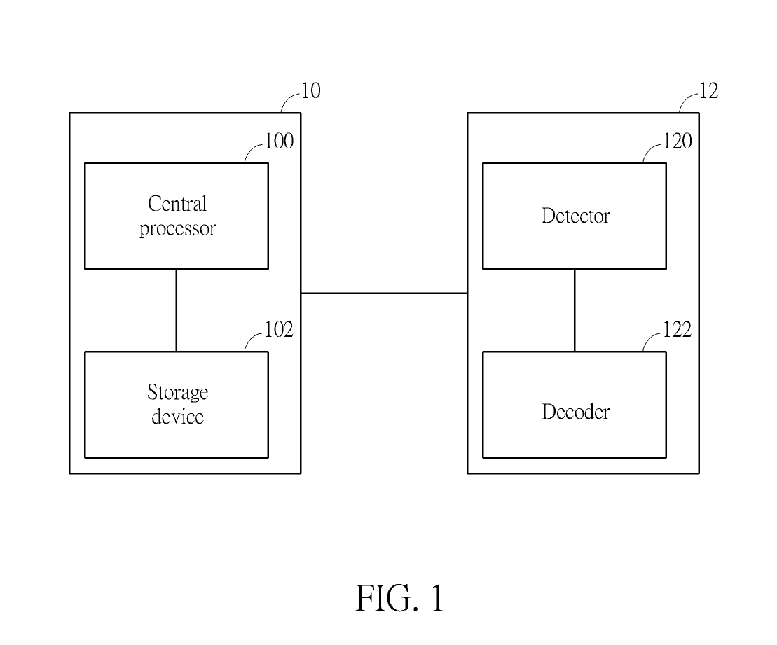

Please refer to FIG. 1, which illustrates a schematic diagram of a computer system 10 according to an embodiment of the invention. As shown in FIG. 1, the computer system 10 is coupled to a wireless communication system 12, and comprises a central processor 100 and a storage device 102. The storage device 102 of the computer system 10 stores a program code which instructs the central processor 100 to execute a method which can effectively reduce an inter-cell interference (ICI) and an inter-antenna interference (IAI) of the wireless communication system 12. In the embodiment, the wireless communication system 12 comprises a receiving end and comprises at least a detector 120 coupled to a decoder 122, and in another embodiment, the wireless communication system 12 may also comprise other functional composition elements corresponding to the receiving end for communicative operations. For example, if the wireless communication system 12 is a long term evolution (LTE) system, and the wireless communication system 12 may comprise an evolved core network, at least one evolved node B (eNB), and/or at least one user device. Moreover, both the detector 120 and the decoder 122 may be disposed inside the user device and the eNB for exchanging communication packets when a communication is bridged between the user device and the eNB. In other words, the detector 120 and the decoder 122 of the embodiment may be an integration of any communication device utilized in the wireless communication system 12, and certainly, the computer system 10 and the wireless communication system 12 can also be functionally integrated together, which is not limiting the scope of the invention.

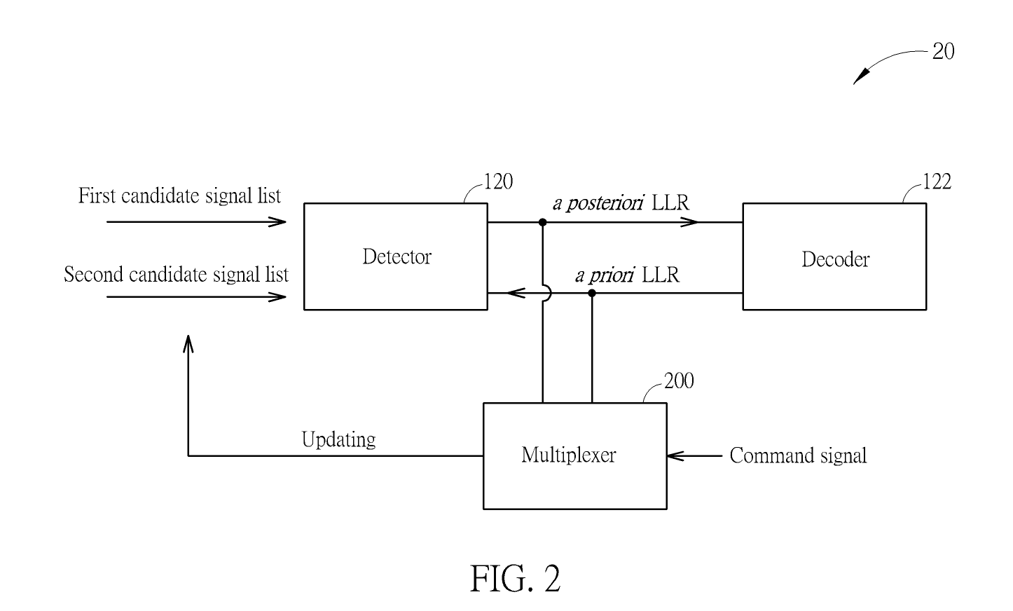

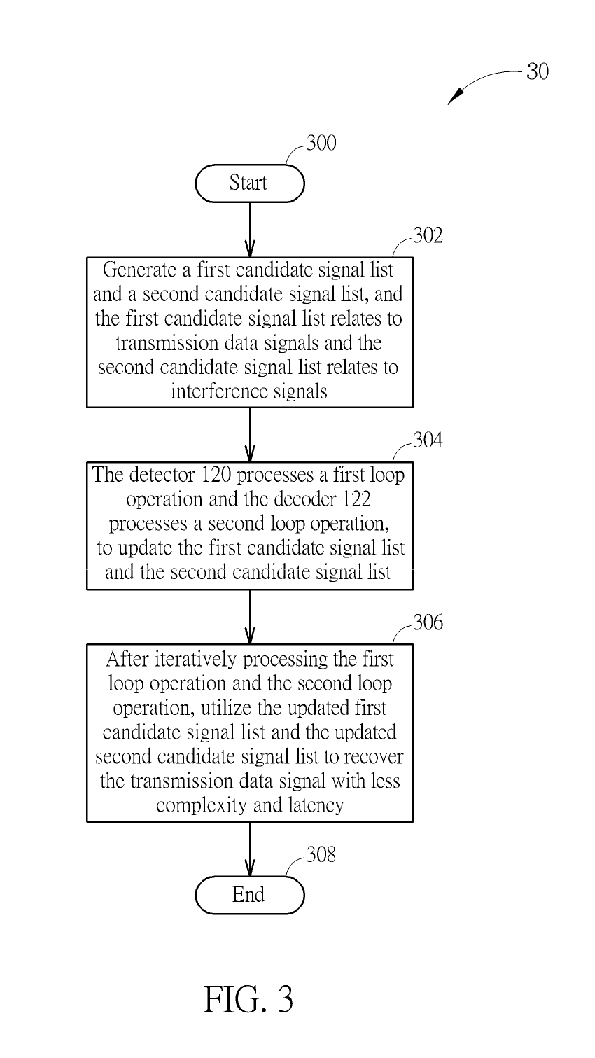

Please refer to FIG. 2 and FIG. 3. FIG. 2 illustrates a schematic diagram of another detailed wireless communication system 20 according to an embodiment of the invention, and FIG. 3 illustrates a process 30 for the wireless communication system 20 shown in FIG. according to an embodiment of the invention. The wireless communication system 20 of the embodiment is similar to the wireless communication system 12 shown in FIG. 1, and further comprises a multiplexer 200 coupled to the detector 120 and the decoder 122. Besides, more transmission signals of the wireless communication system 20 are depicted in FIG. 2. The process 30 of the embodiment can be compiled into the program code and stored in the storage device 102 of the computer system 10, such that the ICI and IAI of the wireless communication system 20 can be effectively reduced after the process 30 has been processed. Further, in another embodiment, the program code can also be separately stored in a storage device of any one (or more than one) of the composition elements in the wireless communication system 20, which is also within the scope of the invention. The process 30 comprises the following steps.

Step 300: Start.

Step 302: Generate a first candidate signal list and a second candidate signal list, and the first candidate signal list relates to transmission data signals and the second candidate signal list relates to interference signals.

Step 304: The detector 120 processes a first loop operation and the decoder 122 processes a second loop operation, to update the first candidate signal list and the second candidate signal list.

Step 306: After iteratively processing the first loop operation and the second loop operation, utilize the updated first candidate signal list and the updated second candidate signal list to recover the transmission data signal with less complexity and latency.

Step 308: End.

In the embodiment of the invention, the process 30 is initially processed to predetermine the first candidate signal list indicating the possible transmission data signals and the second candidate signal list indicating the possible interference signals in step 302, wherein the simulation number of possible transmission data signals as well as the interference signals are not limiting the scope of the invention. Also, a data signal detection criterion corresponding to the first candidate signal list, a first modulation type corresponding to the first candidate signal, and a second modulation type corresponding to the second candidate signal list are predetermined as well, wherein the data signal detection criterion indicates an error correcting scheme corresponding to an encoder for the first candidate signal list. Preferably, a simulation formula of the embodiment is y=Hx+αGz+n, wherein x is a vector of possible transmission data signals, z is a vector of possible interference signals, H is a matrix of transmission channels, G is a matrix of inter-cell interference channel, α is a coefficient that indicating the strength ratio of the inter-cell interference over the data signal and n is a noise vector.

In step 304, by referring to the simulation formula y=Hx+αGz+n, the detector 120 processes the first loop operation and the decoder 122 processes the second loop operation, to update the first candidate signal list (i.e. a list indicating the vector of possible transmission data signals) and the second candidate signal list (i.e. a list indicating the vector of possible interference signals). Preferably, if the wireless communication system 20 has a plurality of operational cycles, the first loop operation can be processed several times and the second loop operation can be processed once in each operational cycle, such that first loop operation and the second loop operation can be iteratively processed in the operational cycles. When the first loop operation is processed, a soft information corresponding to the first loop operation is generated by the detector 120 and transmitted to the multiplexer 200. Next, before the second loop operation is processed, the decoder first receives the soft information generated from the detector 120. After receiving the soft information from the detector 120, another soft information corresponding to the second loop operation is generated by the decoder 122 and transmitted to the multiplexer 200. Under such circumstances, the multiplexer 200 of the embodiment can be utilized to receive and store the soft information corresponding to the first operation loop and the second operation loop for following operations.

In step 306, after the first loop operation and the second loop operation are iteratively processed by the detector 120 and the decoder 122, respectively, the soft information corresponding to the first loop operation or the soft information corresponding to the second loop operation can be repeatedly regenerated and stored in the multiplexer 200 in the operational cycles. Accordingly, the multiplexer of the embodiment is controlled to selectively return the soft information corresponding to the first loop operation or the soft information corresponding to the second loop operation, so as to update both the first candidate signal list and the second candidate signal list. Preferably, in the embodiment, the second candidate signal list may be first updated according to the soft information returned by the multiplexer 200. Next, the first candidate signal list may be updated according to the updated second candidate signal list. After the first candidate signal list and the second candidate signal list have been updated several times, the updated first candidate signal list and the updated second candidate signal list are applied to a receiver of the wireless communication system 20 to recover the transmission data signal.

Preferably, the multiplexer 200 of the embodiment receives a command signal to decide whether the soft information corresponding to the first loop operation or the soft information corresponding to the second loop operation is returned for updating the first candidate signal list and the second candidate signal list. Specifically, the soft information is a log-likelihood ratio (LLR) generated by the detector or by the decoder, and the LLR indicates a bit decision information of symbols in the transmission data signal. For example, in one embodiment, the multiplexer 200 can be set to return the soft information of the decoder once after returning the soft information of the detector five times, and according to different requirements, the command signal and a switching mechanism thereof can also be adaptively modified to control how many times for the detector 120 or the decoder 122 should be processed to return the corresponding soft information, which is not limiting the scope of the invention.

Noticeably, the first loop operation of the embodiment involves the detector which provides a posteriori LLR during a first processing period, the second loop operation of the embodiment involves a forward error coding (FEC) decoder which provides a priori LLR during a second processing period, wherein the first processing period is shorter than the second processing period. In detail, a posteriori LLR has an advantage of shorter calculating periods with less precise estimation of LLR. In contrast, a priori LLR has an advantage of more precise estimation of LLR, but a longer latency and complex calculating burdens may be anticipated. Under such circumstances, the embodiment of the invention utilizes the multiplexer 200 to adaptively integrate the two loop operations and to selectively return the corresponding soft information generated by the detector or by the decoder, such that the first candidate signal list and the second candidate signal can be efficiently updated with superior accuracy in a shorter calculating period. In comparison with the prior art such as the joint detection, the embodiment of the invention adopts two operation loops as well as the two updating candidate signal lists, such that the two candidate signal lists can be efficiently generated to recover the potential transmission signals, and the corresponding estimation process only requires fewer complexity and latency. In comparison with the prior art such as the SIC, the embodiment of the invention considers more than one estimated interference signals, alleviating the occurrence probability of error propagation and exhibiting a lower bit error rate.

In summary, the embodiments of the invention utilize two candidate signal lists and two operation loops to adaptively reduce the ICI and the IAI in a wireless communication system. By combining both the advantages of the two operation loops, the two candidate signal lists can be efficiently updated, such that the embodiment only requires fewer calculating periods but still has higher accuracy (i.e. lower BER), and the updated two candidate signal lists can be utilized to recover the potential transmission packets, so as to significantly reduce the ICI and the IAI of the wireless communication system.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for reducing an inter-cell interference (ICI) and an inter-antenna interference (IAI) in a wireless communication system, the method comprising:
generating a first candidate signal list and a second candidate signal list, wherein the first candidate signal list relates to transmission data signals, and the second candidate signal list relates to interference signals;
processing, via a detector, a first loop operation, and processing, via a decoder, a second loop operation, to update the first candidate signal list and the second candidate signal list; and
after iteratively processing the first loop operation and the second loop operation, utilizing the updated first candidate signal list and the updated second candidate signal list to recover the transmission data signal with less complexity and latency.

2. The method of claim 1, wherein the step of processing, via the detector, the first loop operation, and processing, via the decoder, the second loop operation, to update the first candidate signal list and the second candidate signal list comprises:
in an operational cycle, processing the first loop operation several times and then processing the second loop operation once; and
iteratively processing the operational cycle.

3. The method of claim 1, further comprising inputting a command signal to decide whether a soft information corresponding to the first loop operation or another soft information corresponding to the second loop operation is returned for updating the first candidate signal list and the second candidate signal list.

4. The method of claim 3, wherein the soft information is a log-likelihood ratio (LLR) generated by the detector or the decoder, and the LLR indicates a bit decision information of symbols in the transmission data signal.

5. The method of claim 4, wherein whenever the second candidate signal list is updated according to the soft information from the detector or the decoder, the first candidate signal list is updated according to the updated second candidate signal list, and accordingly, the software information is regenerated according to the updated first candidate signal list and the updated second candidate signal list.

6. The method of claim 1, wherein a data signal detection criterion corresponding to the first candidate signal list, a first modulation type corresponding to the first candidate signal, and a second modulation type corresponding to the second candidate signal list are predetermined.

7. The method of claim 1, wherein the first loop operation involves the detector which provides a posteriori LLR during a first processing period, the second loop operation involves a forward error coding (FEC) decoder which provides a priori LLR during a second processing period, and the first processing period is shorter than the second processing period.

8. A computer system, coupled to a wireless communication system comprising a detector and a decoder, the computer system comprising:
a central processor; and
a storage device, coupled to the central processor, for storing a program code;
wherein the program code instructs the central processor to execute a method for reducing an inter-cell interference (ICI) and an inter-antenna interference (IAI) in the wireless communication system, and the method comprises:
generating a first candidate signal list and a second candidate signal list, wherein the first candidate signal list relates to transmission data signals, and the second candidate signal list relates to interference signals;
processing, via the detector, a first loop operation, and processing, via the decoder, a second loop operation, to update the first candidate signal list and the second candidate signal list; and
after iteratively processing the first loop operation and the second loop operation, utilizing the updated first candidate signal list and the updated second candidate signal list to recover the transmission data signal with less complexity and latency.

9. The wireless communication system of claim 8, wherein the step of processing, via the detector, the first loop operation, and processing, via the decoder, the second loop operation, to update the first candidate signal list and the second candidate signal list comprises:
in an operational cycle, processing the first loop operation several times and then processing the second loop operation once; and
iteratively processing the operational cycle.

10. The wireless communication system of claim 8, wherein the method further comprises inputting a command signal to decide whether a soft information corresponding to the first loop operation or another soft information corresponding to the second loop operation is returned for updating the first candidate signal list and the second candidate signal list.

11. The wireless communication system of claim 10, wherein the soft information is a log-likelihood ratio (LLR) generated by the detector or the decoder, and the LLR indicates a bit decision information of symbols in the transmission data signal.

12. The wireless communication system of claim 11, wherein whenever the second candidate signal list is updated according to the soft information from the detector or the decoder, the first candidate signal list is updated according to the updated second candidate signal list, and accordingly, the soft information is regenerated according to the updated first candidate signal list and the updated second candidate signal list.

13. The wireless communication system of claim 8, wherein a data signal detection criterion corresponding to the first candidate signal list, a first modulation type corresponding to the first candidate signal, and a second modulation type corresponding to the second candidate signal list are predetermined.

14. The wireless communication system of claim 8, wherein the first loop operation involves the detector which provides a posteriori LLR during a first processing period, the second loop operation involves a forward error coding (FEC) decoder which provides a priori LLR during a second processing period, and the first processing period is shorter than the second processing period.
